(19) United States
(12) Patent Application Publication
(10) Pub. No.: US 2024/0386044 A1
(43) Pub. Date: Nov. 21, 2024

(54) INTELLIGENT SUPPORT ASSISTANT TREE GENERATION

(71) Applicant: SAP SE, Walldorf (DE)

(72) Inventors: Rupam Ojha, Varanasi (IN); Ajay Anand Verma, Uttar Pradesh (IN); Srinivasan Ramanathan, Bangalore (IN); Priyanka Aggarwal, Delhi (IN); Mohit Pratap Singh, Faridabad (IN); Rohit Kumar, Patna (IN); Sudhir Verma, Gurgaon (IN)

(21) Appl. No.: 18/198,378

(22) Filed: May 17, 2023

(51) Int. Cl. G06F 16/35; G06F 16/31; G06F 16/33

(52) U.S. Cl. CPC G06F 16/353; G06F 16/322; G06F 16/3347

(57) ABSTRACT

Support for a product may be provided using an interactive chat interface. The interface may provide recommendations for actions the user may take to address the issue. A support assistant tree may be used in providing information to the user via the user interface. The user interface may include options selectable by the user to traverse the support assistant tree. For example, a server may initially record the state of the user as being at the root node of the support assistant tree. Each child node of the root node may be associated with an answer to a question or an option. When the user selects the associated answer or option, the server provides information related to the corresponding node and updates the recorded state of the user to be the corresponding node. The process may be repeated until a leaf node is reached.

### TECHNICAL FIELD

The subject matter disclosed herein generally relates to automated systems for user interaction. Specifically, the present disclosure addresses systems and methods to automatically generate an intelligent support assistant tree.

### BACKGROUND

A tree is a type of directed acyclic graph data structure comprising nodes and edges. Each tree has a single root node that has no parent nodes. The root note may have child nodes. Each child node may have further child nodes. A node without children is a leaf node.

A support assistant tree is a tree in which each leaf node corresponds to a recommendation. By navigating the support assistant tree, a user may find a recommendation suitable for a problem the user is facing. Each node may have a corresponding question or prompt that helps the user navigate the tree. The support assistant tree may be manually created by a subject-matter expert.

### BRIEF DESCRIPTION OF THE DRAWINGS

FIG. 1 is a network diagram illustrating an example network environment suitable for intelligent support assistant tree generation.

FIG. 2 is a block diagram of an application server, suitable for intelligent support assistant tree generation, according to some example embodiments.

FIG. 3 is a block diagram of a machine learning model, suitable for use in intelligent support assistance tree generation, according to some example embodiments.

FIG. 4 is a block diagram of a language embedder, suitable for generating vector representation of input text, according to some example embodiments.

FIG. 5 is a flow diagram showing generation of an intelligent support assistant tree, according to some example embodiments.

FIG. 6 is a block diagram of an example database schema suitable for use by a system that intelligently generates support assistant trees.

FIG. 7 is a portion of an example support assistant tree, according to some example embodiments.

FIG. 8 is a flow diagram showing the use of hierarchical agglomerative clustering in generating support assistant trees.

FIG. 9 is an example user interface for a user receiving support utilizing a support assistant tree.

FIG. 10 is a flowchart for a method of intelligently generating a support assistant tree, according to some example embodiments.

FIG. 11 is a block diagram showing one example of a software architecture for a computing device.

FIG. 12 is a block diagram of a machine in the example form of a computer system within which instructions may be executed for causing the machine to perform any one or more of the methodologies discussed herein.

### DETAILED DESCRIPTION

Example methods and systems are directed to intelligent support assistant tree generation. A user may have an issue with a product. To get support, the user accesses a support interface for the product. For example, a web page may include a list of supported products and the user may select the product currently having an issue.

Support for the product may be provided using an interactive chat interface. The interface may provide recommendations for actions the user may take to address the issue. A support assistant tree may be used in providing information to the user via the user interface. The user interface may include options selectable by the user to traverse the support assistant tree. For example, a server may initially record the state of the user as being at the root node of the support assistant tree. Each child node of the root node may be associated with an answer to a question or an option. When the user selects the associated answer or option, the server provides information related to the corresponding node and updates the recorded state of the user to be the corresponding node. If the newly selected node has child nodes itself, the process may be repeated until a leaf node is reached.

Existing support assistant trees may be generated by subject-matter experts in a manual process. Due to the level of effort involved, support assistant trees are rarely updated. As discussed herein, data for previously handled support incidents is used to automatically generate an intelligent support assistant tree. The automated process may be repeated to update the support assistant tree periodically, to take advantage of additional information in more recently handled support incidents.

A database may store information for support incidents. Each “note” for a support incident may identify the product or product component to which the incident applies, the particular issue of the incident (e.g., program crash, memory error, rejection of user input, or any suitable combination thereof), text comprising a recommendation to address the problem, or any suitable combination thereof.

To generate a support assistant tree for a product or product component, the notes for the support incidents for the product or product component are accessed. The notes are screened for quality (e.g., by removing notes that do not include recommendations) and the text of the qualified notes is converted to a vector format. Using the vector representations of the text, the qualified notes are clustered into groups. The groups are used to generate a tree comprising a root node, zero or more intermediate nodes, and one leaf node for each qualified note. Based on the notes for the individual leaf nodes or the notes for each qualified note in each group for intermediate nodes, a text option is generated that corresponds to each intermediate node and each leaf node. The text option is used to assist a user in traversing the support assistant tree.

Generating the support assistant tree may be a multi-step process in which initial and intermediate trees are generated before the final tree is generated. An initial tree may be a binary tree generated by pairwise associating each qualified note with its closest neighbor (e.g., using a distance measure between the representative vectors for each qualified note) and assigning each pair as child nodes of a new intermediate node. A vector representation of each intermediate node may be determined by averaging the vectors of the child nodes, and the process may be repeated, causing each closest pair of intermediate nodes to be sibling nodes under a new parent node. The new parent nodes, themselves, are intermediate nodes and the process can continue. At each level, the number of nodes is half the number of nodes at the preceding level; eventually a level is reached with only one node, the root node of the tree.

The binary tree may be modified using recursive restructuring based on preferences between maximum or average depth of the tree and maximum or average width of the tree. For example, an administrator may specify that the shortest possible depth is desired such that no node has more than five children. Recursive restructuring will remove intermediate nodes while maintaining the similarity of nodes that are grouped together.

In addition to or instead of using vectors that represent meaning using natural language processing, vectors based on a term-frequency matrix may be used. The term-frequency matrix may be generated based on the qualified notes. Each row of the matrix corresponds to a different qualified note. Each column of the matrix corresponds to a different word or phrase observed in the qualified notes. Each cell indicates the frequency of the corresponding term in the corresponding note. The frequencies may be normalized to a range of 0.0-1.0. A vector may be created for each note that comprises the values of the row for the note. The vectors may be compared using cosine similarity, such that identical vectors will have a similarity of 1.0 and orthogonal vectors will have a similarity of 0.0.

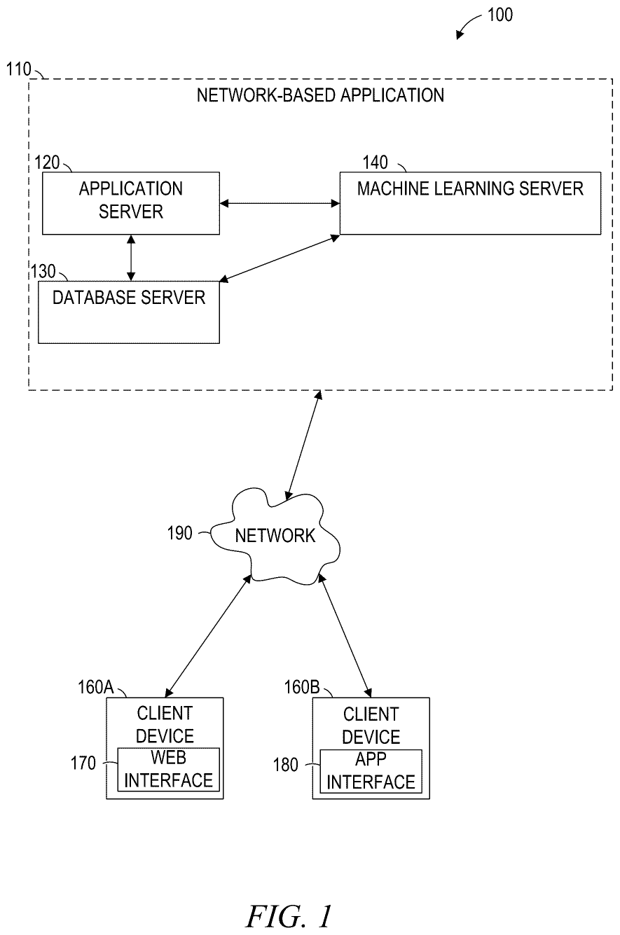

FIG. 1 is a network diagram illustrating an example network environment 100 suitable for intelligent support assistant tree generation. The network environment 100 includes a network-based application 110, client devices 160A and 160B, and a network 190. The network-based application 110 is provided by an application server 120 in communication with a database server 130 and a machine-learning server 140. The application server 120 accesses application data (e.g., application data stored by the database server 130) to provide one or more applications to the client devices 160A and 160B via a web interface 170 or an application interface 180.

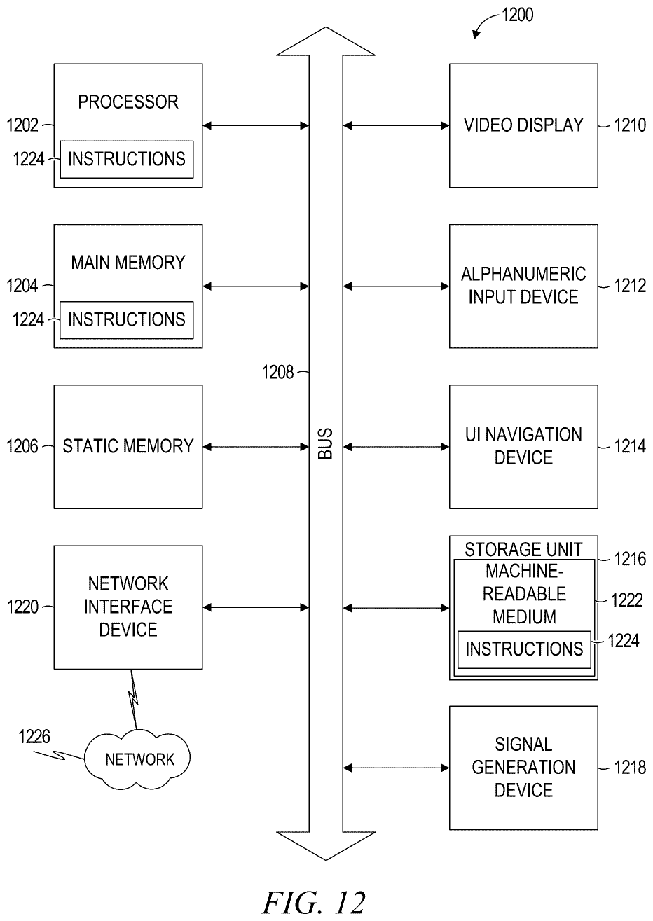

The application server 120, the database server 130, the machine-learning server 140, and the client devices 160A and 160B may each be implemented in a computer system, in whole or in part, as described below with respect to FIG. 12. The client devices 160A and 160B may be referred to collectively as client devices 160 or generically as a client device 160.

Users of the network-based application 110 may request information using an interactive chat interface. For example, a user may have questions about how to use certain features of the network-based application 110 or another application. Automated responses to user queries may be provided using a support tree.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the machine-learning server 140, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one network-based application 110, two client devices 160A-160B, and the like), any number of each element is contemplated. For example, the application server 120 may access data from dozens or hundreds of data sources and provide an application to millions of client devices.

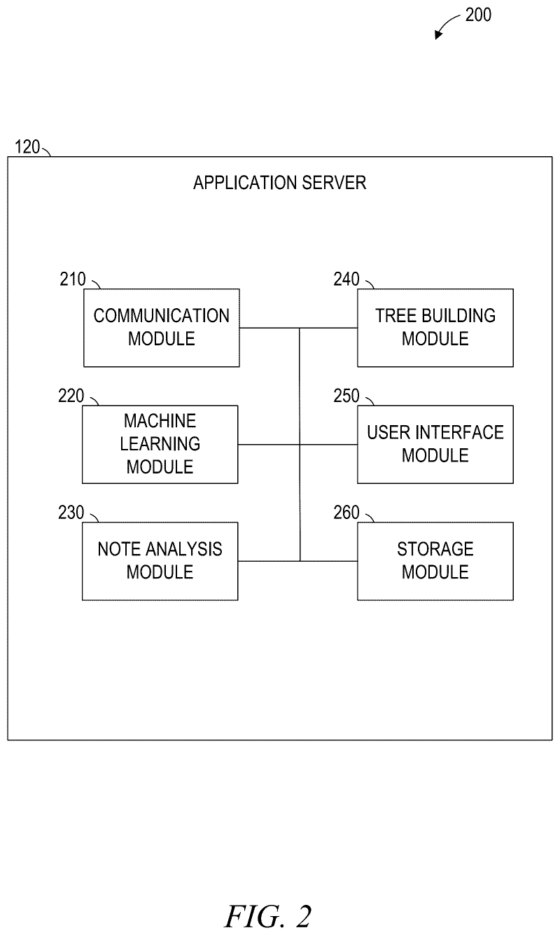

FIG. 2 is a block diagram of an application server 120, suitable for intelligent support assistant tree generation, according to some example embodiments. The application server 120 is shown as including a communication module 210, a machine learning module 220, a note analysis module 230, a tree building module 240, a user interface module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 120 and transmits data from the application server 120. For example, the communication module 210 may receive, from the client device 160A or 160B, a request for help with an application provided by the application server 120.

The machine learning module 220 trains a machine-learning model using training data, uses the trained machine-learning model to generate output for input data, or both. For example, the machine-learning model may be trained, using a database of previous support requests, to predict an answer for a user's question based on the question. Thereafter, the machine-learning model may receive future questions from users as input and generate answers. Machine-learning models may also be used for natural language processing (NLP). Input text is mapped to vectors in a high-dimensional space (e.g., vectors of hundreds or thousands of elements) such that words with similar meanings have vectors that are closer together than words with dissimilar meanings. Additionally, relationships between vectors may be maintained. For example, the relationship between the vector for “king” and “queen” may be the same as the relationship between the vector for “man” and “woman.” Thus, manipulation of vectors may have semantic meaning when the vectors are converted back to human-readable language.

Note analysis may be performed by the note analysis module 230. For example, each “note” may comprise text generated by a technical support staff member in response to a particular problem raised by a user. The text may be analyzed by converting it to a vector representation and providing the vector representation as input to a machine-learning model. For example, a topic of the note may be determined by the output of the machine-learning model. Other note analysis may include generating a count of terms used in the note. For example, a vector may be created that includes one element for each known term. The value of each element may be the count of the term in the note. Thus, similar notes will have similar vectors while notes on unrelated topics will have dissimilar vectors.

The tree building module 240 generates a support assistant tree based on the analysis provided by the note analysis module 230. For example, a tree may be generated that includes a root node, a leaf node for a plurality of notes, and zero or more intermediate nodes. Related notes may be placed closer together in the tree, so that navigating the tree from the root node to a leaf node follows a logical progression of steps in which a user's question is refined at each level. Labels may be generated for each intermediate node.

A user interface for traversing the support assistant tree is provided by the application server 120 using the user interface module 250. For example, a hypertext markup language (HTML) document may be generated by the user interface module 250, transmitted to a client device 160 by the communication module 210, and rendered on a display device of the client device 160 by a web browser executing on the client device 160. The user interface may comprise text fields, drop-down menus, and other input fields. For example, the user may be prompted with the labels of the child nodes of the root node and enabled to select one of the labels, and thus one of the nodes. After the selection is made, the user may be presented with labels for child nodes of the selected nodes. The process may repeat until the user has selected a leaf node, at which time the user is presented with the note associated with the leaf node, which may help the user resolve an issue.

Queries, results, notes, machine-learning models, training data,, or any suitable combination thereof may be stored and accessed by the storage module 260. For example, local storage of the application server 120, such as a hard drive, may be used. As another example, network storage may be accessed by the storage module 260 via the network 190.

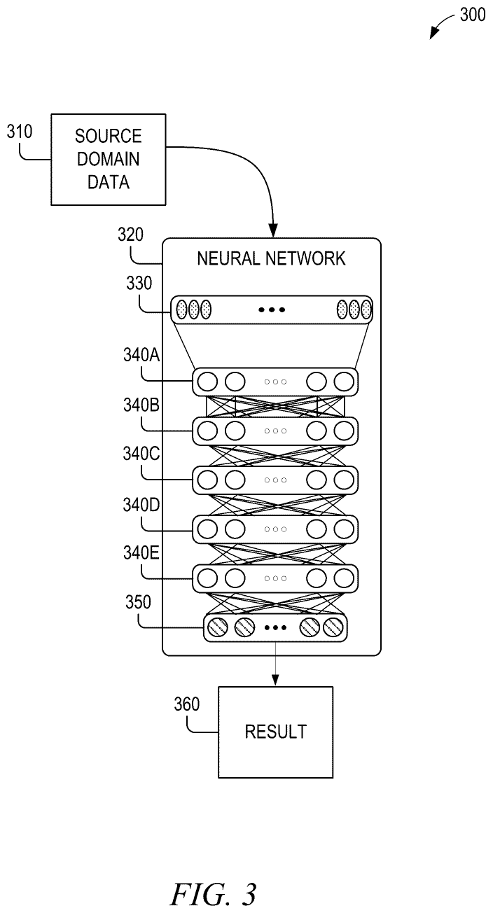

FIG. 3 illustrates the structure 300 of a neural network 320, according to some example embodiments. The neural network 320 takes source domain data 310 as input and processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between 1 and the size of the training dataset while the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like.

With the help of natural language processing (NLP) and advanced data pre-processing, a machine learning model (e.g., the neural network 320) can be trained on all historical (existing) business entities (for instance, incidents, email interactions, etc.) from the system to assign them with a certain set of keywords or a dominant topic label based on textual fields such as description, subject, and so forth.

A topic label can be a human-readable phrase or word specific to the industry that it belongs to. It can be determined based on a set of keywords. For instance, if an object contains a long text of multiple words, this model will detect the most “relevant” and “important” keywords and assign them to different ensembles based on multiple factors. Some factors include feature importance and linguistic proximity. Linguistic proximity refers to a distance between vector representations of keywords in two (or more) textual inputs. Additional factors include word commonalities, n-gram commonalities, and the like.

Related data objects may be assigned a human-legible “topic.” Based on the existing topics and the contents of a new data object, the new data object is automatically assigned to one of the existing topics.

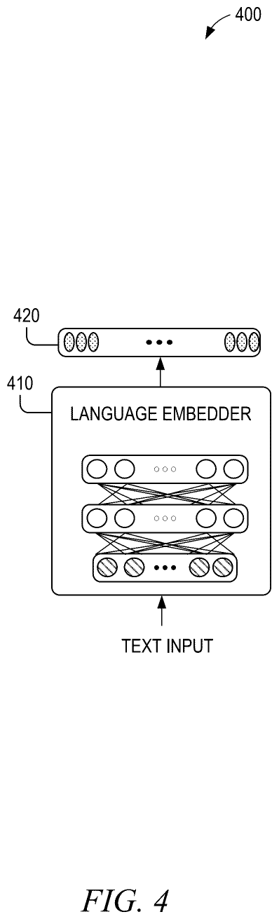

FIG. 4 is a block diagram 400 of a trained language embedder 410, according to some example embodiments, suitable for use in generating word vectors. The language embedder 410 generates resulting vector 420. The language embedder 410 is trained so that the distance (or loss) function for two related text fields is reduced or minimized.

The specific architecture of the language embedder 410 may be chosen dependent on the type of input data for an embedding layer that is followed by some encoder architecture that creates a vector from the sequence. Embeddings and encoder parameters are shared between the text fields. In the simplest case, the encoder stage is just an elementwise average of the token embeddings.

In some example embodiments, the word vectors are normalized so that each word vector has a magnitude of one. A vector for text comprising multiple words may be obtained by averaging the vectors of the words in the text. To determine the difference between two vectors, the Euclidean distance formula may be used, taking the square root of the sum of the squares of the differences of corresponding elements of the two vectors.

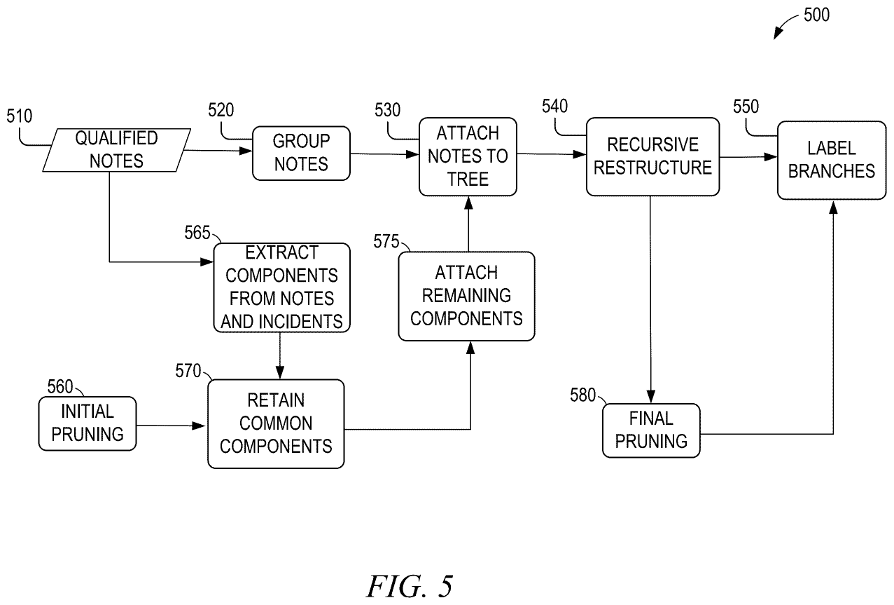

FIG. 5 is a flow diagram showing a method 500 for generation of an intelligent support assistant tree, according to some example embodiments. The input to the method 500 is the qualified notes 510. A database comprising notes is accessed. Notes from the database are selected based on criteria such as the product the note pertains to. The selected notes are qualified based on additional criteria, such as the date on which the note was created, the number of times the note has been accessed, the number of incidents associated with the note, the software version addressed by the note, or any suitable combination thereof.

The qualified notes 510 are grouped in operation 520, labeled “group notes.” For example, the qualified notes 510 may be grouped based on incident components, note components, product function addressed by the notes, or any suitable combination thereof.

The qualified notes 510 are added to a tree in operation 530, labeled “attach notes to tree.” In various example embodiments, the method by which the notes are added to the tree varies. For example, an initial tree may be generated based on a pre-existing hierarchy of product components or an existing tree (e.g., an expert-created tree or a tree created in a previous iteration of the method 500). The notes may be attached to the initial tree according to a product component identified in the note. For notes that identify multiple product components, the note may be added to the tree multiple times, once for each component.

As another example, a branch of the tree may be created for each group of notes generated in operation 520. Any notes not in any group are associated with an “Others” branch. Each note is attached as a child node of the node for its group.

In some example embodiments, multiple views of the tree are supported. Some nodes may be visible in a subset of the views. To support this, each node may have a bitmap assigned to it, in which each bit in the bitmap indicates whether the node is visible in a corresponding view. For example, a six-bit number may be assigned to each node to support six views. One bit of the six-bit number may be for a Hot Topics view that shows nodes that have been accessed at least a threshold number of times in a predetermined time period (e.g., the past 24 hours or the past week). Another bit of the six-bit number may be for a New Recommendations view that shows notes that were created within a predetermined time period (e.g., the past 24 hours or the past week). A third bit of the six-bit number may be for a Software Versions view that shows notes associated with predetermined Software Versions (e.g., a current version and a previous version).

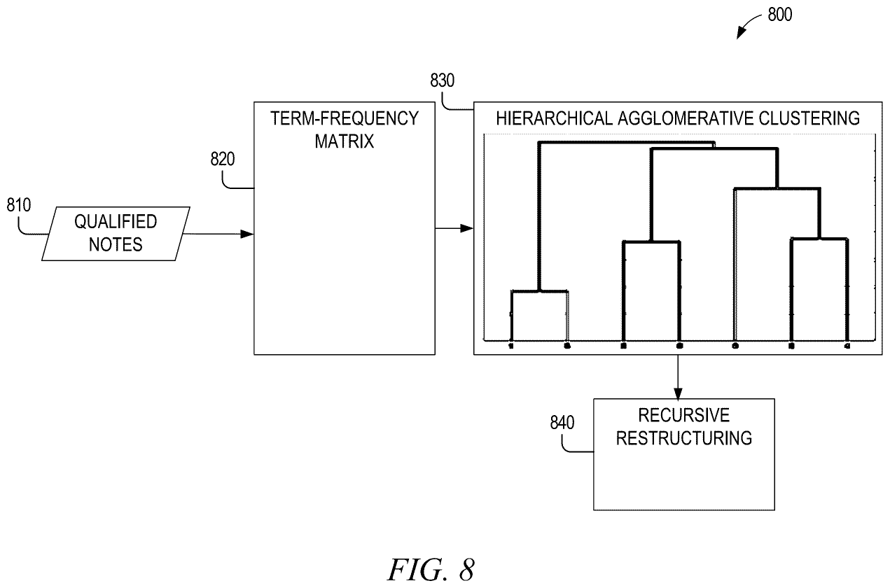

The tree created in operation 530 may not be very user-friendly. For example, one node of the tree may have a large number of children and a leaf node may be accessible only by traversing a large number of intermediate nodes. The tree is restructured in operation 540, labeled “recursive restructure,” to generate a tree that is wider and shallower. Methods for restructuring are discussed in more detail with respect to FIG. 8, addressed below.

After the structure of the tree is determined, the branches are labeled in operation 550, “label branches.” In branch labeling, dependency parsing and topic extraction techniques may be used to generate the labels. For example, the text of all leaf nodes below the node being labeled may be used as input to a machine-learning model that generates a topic for the input text. The generated topic may be used as the label for the node.

Operation 560, “initial pruning,” may be performed on a base tree structure. For example, the base tree structure may comprise nodes corresponding to software components and the tree being generated may only apply to certain components. Nodes for other components may be removed at this stage.

The components of the notes and incidents are extracted from the qualified notes 510 in operation 565. The components identified in operation 565 are used in operation 570, “retain common components,” to further prune the tree. Components present in the base tree structure but not referred to in the qualified notes 510 may be removed from the base tree structure.

In operation 575, “attach remaining components,” any components identified in operation 565 that are not part of the base tree structure are added. For example, a temporary tree may be generated with a dummy root node and child nodes according to a component hierarchy. To illustrate, consider components “XX-YY-ZZZZ,” “XX-AA,” and “BB-CCC-DDDD,” with each hyphen-separated grouping representing a different component or sub-component. Then the children of the dummy root node are “XX” and “BB.” The children of “XX” are “XX-YY” and “XX-AA.” The child of “XX-YY” is “YY-ZZZZ.” The child of “BB” is “BB-CCC.” The child of “BB-CCC” is “BB-CCC-DDDD.”

A flag may be assigned to each node in the tree, such that the nodes corresponding to the components identified in operation 565 have the flag set to true and the other nodes have the flag set to false. Any node with the flag set to true or with all child nodes having the flag set to true will be added to the base tree structure. To add the node, a suitable place is identified in the base tree structure. If the component of the node in the temporary tree is present in the base tree, the node is added to the same place in the base tree. Otherwise, the node is added to the “others” branch. The resulting tree may be used in operation 530, as the tree to which notes are attached.

In operation 580, “final pruning,” additional nodes of the tree may be removed. For example, the nodes of the base tree structure may have a flag set to true if they are notes or have notes attached and have the flag set to false otherwise. Sub-trees in which all nodes have the flag set to false may be removed. In some example embodiments, all nodes with the flag set to false are removed. A node with a removed parent becomes a child of its parent's parent. If that node is also removed, the node moves another level up the tree and may become a child of the root node, which is never removed.

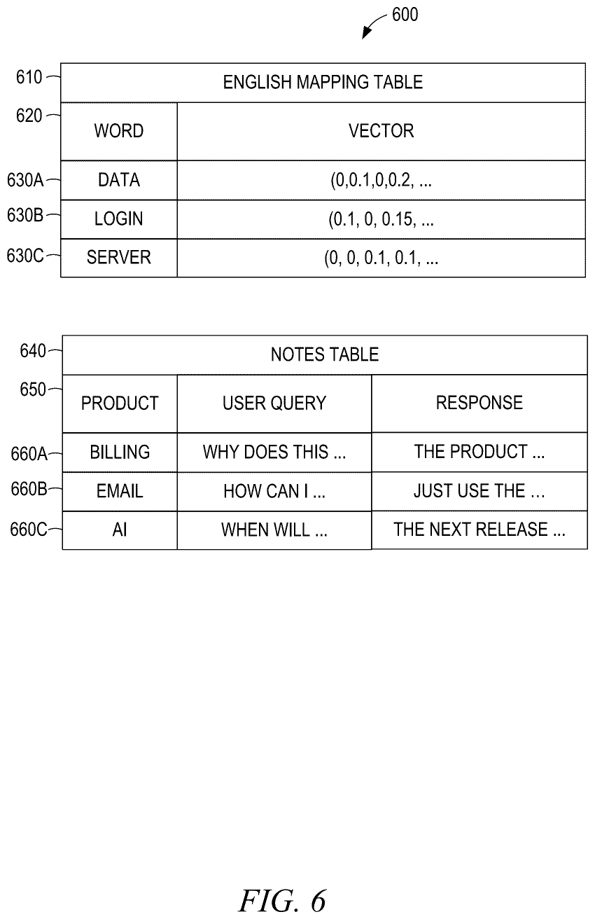

FIG. 6 is a block diagram of an example database schema 600 suitable for use by a system that intelligently generates support assistant trees. The database schema 600 includes an English mapping table 610 and a notes table 640. The English mapping table 610 includes rows 630A, 630B, and 630C of a format 620. The notes table 640 includes rows 660A, 660B, and 660C of a format 650.

Each row of the English mapping table 610 contains the embedding vector for an input English word. The contents of the English mapping table 610 may be generated by the trained language embedder 410 of FIG. 4. Once fully trained, the embeddings for a dictionary of English terms may be generated and stored in a database table for more efficient access. The embeddings may be accessed from the database table to generate vector representations of documentation in source code. Alternatively, the trained language embedder 410 may be used to generate embeddings dynamically, without the use of the English mapping table 610. The trained language embedder 410 may be able to generate accurate embeddings for variations of words or phrases not found in the dictionary.

The format 650 of the notes table 640 indicates that each of the rows 660A-660C identifies a product, a user query, and a response. For example, the row 660A includes a query regarding a billing product and the response to the query. The data in the notes table 640 may be qualified and used as the qualified notes 510 in the method 500 of FIG. 5. Additional columns may be included in the notes table 640, such as a product component, a unique identifier, or both. Additionally, notes and incidents may be stored in separate tables, allowing notes to be associated with multiple incidents.

Though the database schema 600 shows only a few tables and only a few rows, any number of tables and rows are contemplated. For example, the English mapping table 610 may store vectors for thousands, hundreds of thousands, or millions of words and phrases. Likewise, the notes table 640 may store hundreds, thousands, or millions of user queries and responses.

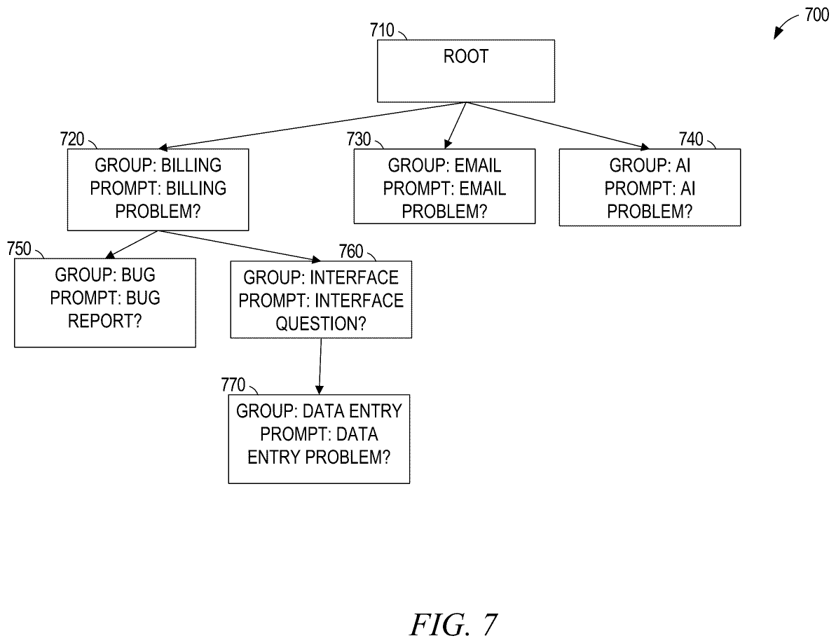

FIG. 7 is a portion of an example support assistant tree 700, according to some example embodiments. The support assistant tree 700 includes nodes 710, 720, 730, 740, 750, 760, and 770. The node 710 is the root node, the only node that has no parents.

Each other node 720-770 has a group identifier and a prompt. A user interface may be generated based on the support assistant tree 700. Initially, the current node is set to the root node. The user interface presents the user with one or more prompts from the child nodes of the current node. After the user selects a prompt, the current node is updated to the node corresponding to the selected prompt. The user interface may sequentially ask the user a series of yes/no questions or present multiple options simultaneously.

The process is repeated until the current node is a leaf node that is associated with an individual note. Text from the note (e.g., text stored in the response column of the notes table 640) is presented to the user. The user may be asked if the information resolved the problem. If the information resolved the problem, that data may be stored as validating the usefulness of the note. If the information did not resolve the problem, that data may be stored as indicating that the note was not helpful. Additionally, the user may be routed to a human assistant for further help.

FIG. 8 is a flow diagram 800 showing the use of hierarchical agglomerative clustering 830 in generating support assistant trees. The qualified notes 810 are used as input. For example, the notes table 640 of FIG. 6 may be accessed. Notes from the database are selected based on criteria such as the product the note pertains to. The selected notes are qualified based on additional criteria, such as the date on which the note was created, the number of times the note has been accessed, the number of incidents associated with the note, the software version addressed by the note, or any suitable combination thereof.

The qualified notes 810 are used to generate a term-frequency matrix 820. Each row of the term-frequency matrix 820 corresponds to one qualified note. Each column of the term-frequency matrix 820 corresponds to one word or phrase. The value of each cell in the term-frequency matrix 820 represents the number of occurrences of the word or phrase of the column in the qualified note of the row. Each row of the term-frequency matrix 820 may be treated as a vector representing the contents of the corresponding qualified note. The vectors may be normalized so that the sum of the elements is equal to one so that the magnitude of the vector is equal to one.

A filtering method may be applied to filter out the words or phrases (also referred to as n-grams) which are very rare and very common. A threshold parameter for rare phrases may be set to 2 notes, such that if an n-gram appears in fewer than 2 notes then it will be considered as very rare and will not be included in the term-frequency matrix. A threshold parameter for common phrases may be set to 90% of notes, such that if an n-gram appears in more than 90% of notes, then it will be considered as very common and will not be included in the term-frequency matrix. Thus, n-grams that have a frequency outside of a predetermined frequency range may be filtered from the term-frequency matrix. As a result, the vector representation of the text will not include the filtered n-grams, and converting the text for each entry to a vector representation comprises ignoring the filtered n-grams.

A binary tree may be formed that comprises one leaf node for each qualified note. The vectors for the qualified notes may be compared and leaf nodes paired based on the comparisons. For example, the most-similar vector for each leaf node may be identified. An intermediate node is created for each pair, with the two members of the pair placed as child nodes of the new node. The process is repeated, halving the number of nodes at each level, until a level is created with only one node, the root node for the binary tree.

A distance between each pair of notes is determined, as each note will be treated as a separate cluster initially. The distance describes how closely related the two notes in the pair are. Each note is represented by a vector of the size of the vocabulary (including words and phrases), which can be referred as a term-frequency vector, and distance between two notes is calculated as “1−cosine” similarity. A distance matrix of size M×M is generated which contains distance between each pair of notes, where M is the number of notes. This distance matrix is used as an input for hierarchical clustering method.

A distance between two clusters may be calculated using Ward's method for identifying closest pairs of clusters. Ward's distance is the increase in sum of square distance from the centroid of the group, when two clusters are grouped together. For example, if A and B are two clusters with centroids μₐ and μ_{b} respectively, μ_{ab} is the centroid of cluster AB formed by combining A and B. Then Ward's distance d_{A,B} is calculated as

$${d}_{A , B} = {\sum }_{i = 1}^{{n}_{AB}} {( {v}_{i} - {μ}_{ab} )}^{2} - [ {\sum }_{j = 1}^{{n}_{A}} {( {v}_{j} - {μ}_{a} )}^{2} + {\sum }_{k = 1}^{{n}_{B}} {( {v}_{k} - {μ}_{b} )}^{2} ]$$

Where n_{AB} is number of notes in grouped cluster AB, n_{A} is number of notes in cluster A, n_{B} is number of notes in cluster AB, and νᵢ is the term-frequency vector of the i^{th} note.

The below steps are repeated for hierarchical agglomerative clustering 830 using Ward's linkage distance until all the clusters are merged at a root node.
Step 1: Initialize all notes/data points as separate clusters.
Step 2: Identify the pair of closest clusters using Ward's distance based on the vector representations of the text of the cluster.
Step 3: Merge those two closest clusters.
Step 4: Repeat Step 2 to Step 3 until only one cluster is remaining.

A useful data structure to aid in performing the above steps is a linkage matrix. For a term-frequency matrix of N notes, the linkage matrix is of dimension (N−1)×4, where each row of the linkage matrix is an iteration of merging two clusters. Each row contains four values. The first two values identify the clusters being merged. The third column is the Ward's distance of the merged cluster and the fourth column is the size of the merged cluster.

Recursive restructuring 840 is used to build a tree that is wider and shallower than a binary tree. For example, a binary tree composed of 1,024 (2¹⁰) notes would have ten levels. A user may find the process of answering questions or selecting options to navigate to a leaf node to be excessively tedious or time-consuming if ten separate questions must be answered before receiving advice. By contrast, a tree with four options at each level would use only five levels to reach the same number of notes. Recursive restructuring 840 may comprise assigning each group (or cluster) of the plurality of groups to different nodes in a binary tree structure and converting the binary tree structure to the tree structure based on a branching factor constraint.

To perform recursive restructuring, a greedy algorithm may be used, such as that implemented by the pseudo-code below. To create a tree with four options at each level, the branching factor constraint, BRANCHING_FACTOR, is set to 4.
Step 1: CUR_NODE=ROOT
Step 2: While CUR_NODE.children.size<BRANCHING_FACTOR is true, repeat steps from 2 to 4.
Step 3: Identify the child node with maximum distance between its child nodes. MAX_DIST_CHILD=Child with maximum distance
Step 4: Link children of MAX_DIST_CHILD node CUR_NODE CUR_NODE.children=CUR_NODE.children U MAX_DIST_CHILD
Step 5: Delete MAX_DIST_CHILD

Step 6: For child in CUR_NODE.children recursively repeat steps from 1 to 5.

Thus, the two children of the root node are considered to find the node that has the more dissimilar children (Step 3). The two children of that node are promoted to be direct children of the root node (Step 4) and the now-unneeded node is deleted (Step 5). The root node now has three children, which is still less than the BRANCHING_FACTOR in this example (Step 2). The three children are now considered to determine which has the most dissimilar children (Step 3). The children of the found node are promoted to be direct children of the root node (Step 4) and the found node is deleted (Step 5). The root node now has four children, which is equal to the branching factor (Step 2), so the process continues to Step 6 and repeats on the first-level nodes. Once all nodes have been processed, the hierarchical agglomerative clustering is complete.

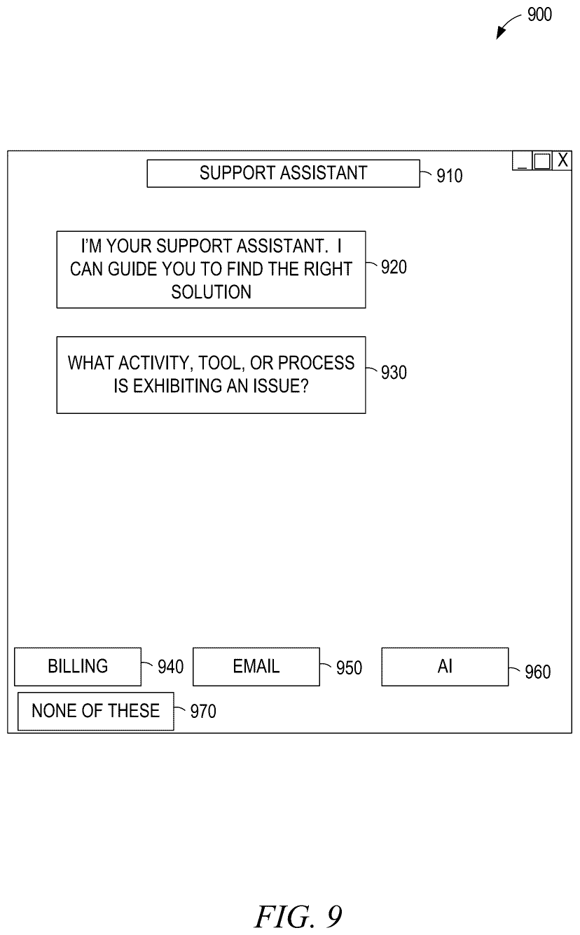

FIG. 9 is an example user interface 900 for a user interacting receiving support utilizing a support assistant tree. The user interface 900 includes a title 910, chat messages 920 and 930, and options 940, 950, 960, and 970. The title 910 indicates that the user interface 900 is for a support assistant. The user interface 900 may be presented to a user via a web interface after the user navigates a website to request support for an application or service.

The support assistant introduces itself in the chat message 920 and asks the user, in chat message 930, to select one of the options 940-970 to begin the support process. The options 940, 950, and 960 correspond to the nodes 720, 730, and 740 of the support assistant tree 700 of FIG. 7. During a support session, a current node of the support assistant tree 700 for the support session is stored. The current node may be initialized at the root node or at a node stored in a previous support session for the user. After selection of one of the options 940-960, the current node may be updated to be the node corresponding to the selected option.

After one of the options 940-960 is selected, an additional chat message may be presented in the user interface 900. The additional chat message comprises either a prompt to select from a new set of options (e.g., options corresponding to child nodes of the current node) or an informational message. For example, if the current node is a leaf node corresponding to an individual note in the notes table 640 of FIG. 6, the response of the note may be presented to the user.

Selection of the option 970 may cause the current node to be set to its parent, allowing the user to reverse course through the support assistant tree 700 and try other options. Alternatively, selection of the option 970 may cause the user to be connected with a support representative, cause the user to be redirected to a knowledge base, or perform another action.

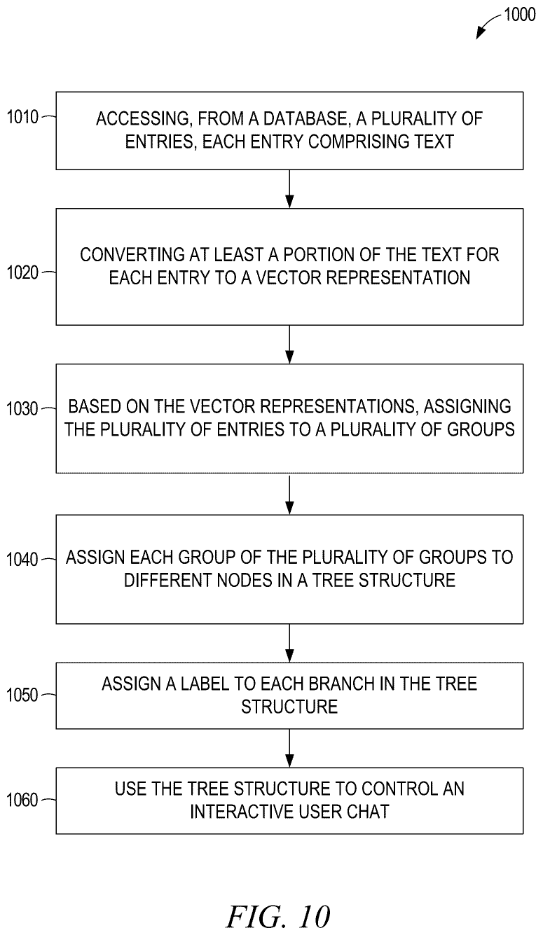

FIG. 10 is a flowchart for a method 1000 of intelligently generating a support assistant tree, according to some example embodiments. The method 1000 includes operations 1010, 1020, 1030, 1040, 1050, and 1060. By way of example and not limitation, the method 1000 may be performed by the application server 120 of FIG. 1, using the modules, databases, structures, and user interfaces shown in FIGS. 2-9.

In operation 1010, the note analysis module 230 of FIG. 2 accesses, from a database (e.g., the notes table 640 of FIG. 6) a plurality of entries (e.g., the rows 660A-660C of the notes table 640), each entry comprising text (e.g., the query and response columns). Each entry may comprise a query from a user requesting support for an application and a response from a support representative. Responses from previous queries may be effective at resolving similar future queries.

In some example embodiments, the database comprises entries for a plurality of product functions and the accessing of the plurality of entries from the database comprises selecting entries for a single product function. The notes table 640 of FIG. 6 is a single table for multiple products. An alternative would be to have one table for each product. An additional column, either in the notes table 640 or in the alternative product tables, would indicate a product function for each note. For example, a billing product may have an invoice entry function, a payment reconciliation function, and so on. As another example, an AI product may have a training function and an execution function. The example support assistant tree 700 is a single support tree for multiple products, but a separate support tree may be created for each product, each product function, or any suitable combination thereof.

The note analysis module 230, in operation 1020, converts at least a portion of the text for each entry to a vector representation. For example, the language embedder 410 of FIG. 4 may be used to generate a vector representing the query of each entry, the response of each entry, or both. As another example, a term-frequency matrix may be generated for the at least a portion of the text for each entry. In the term-frequency matrix, each row is a vector representation of the text in the corresponding entry.

Based on the vector representations, the tree building module 240 of FIG. 2 assigns the plurality of entries to a plurality of groups (operation 1030). The tree building module 240 assigns, in operation 1040, each group of the plurality of groups to different nodes in a tree structure. The hierarchical agglomerative clustering 830 of FIG. 8 may be used to group the entities and assign the groups to nodes in a tree structure.

As an alternative, a tree structure may be prepared that reflects the components of a software product. For example, a root node may correspond to the entirety of the software product. Child nodes of the root node may correspond to primary functions of the software product (e.g., one node for input and another node for output). Grandchild nodes correspond to major sub-functions, and so on. Thus, in this example, the tree structure comprises nodes corresponding to components. In operation 1030, each of the plurality of entries may be mapped to a component. For example, the notes table 640 of FIG. 6 may include a component field. Alternatively, the vectors generated in operation 1020 may be compared to a vector representation of each component to determine a closest match (e.g., using the least Ward's distance). Accordingly, in this example, the plurality of groups in operation 1030 correspond to the components, and the assigning of the groups to the nodes in operation 1040 is based on the components of the software product. For example, each group may be assigned to the node corresponding to the component with the closest match for the vector of the group.

In operation 1050, the tree building module 240 assigns a label to each branch in the tree structure. For example, natural language processing may be used to generate a word or phrase that describes the group, based on the text of the entries in the group. The generated word or phrase may be used as the label. The label (or prompt) may be stored in the tree structure as shown in the support assistant tree 700 of FIG. 7.

The user interface module, in operation 1060, uses the tree structure to control an interactive user chat. For example, the user interface 900 of FIG. 9 may be used.

By virtue of the method 1000, support is provided to a user that allows the user to efficiently find information from previous support interactions (e.g., a knowledge base) without using a database search interface or requiring an expert to create a support assistant tree. Accordingly, effort in providing support is reduced. Also, operations 1010-1050 may repeated periodically (e.g., daily or weekly), automatically updating the support assistant tree and providing updated assistance to the user. By contrast, the level of effort involved in manual creation of support assistant trees is such that updating the support assistant tree is performed rarely (e.g., monthly or yearly) and there may be a substantial delay between the entering of new information into a support database and the promulgation of that information to end users. During the delay period, each user experiencing the same problem will be routed to a human support agent. Thus, the proposed system saves labor and time. Computer resources are saved by virtue of processing requests more quickly, as CPU cycles, network bandwidth consumption, power consumption, and the like are all commensurately reduced.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors configured by the instructions to perform operations comprising: accessing, from a database, a plurality of entries, each entry comprising text; converting at least a portion of the text for each entry to a vector representation; based on the vector representations, assigning the plurality of entries to a plurality of groups; assigning each group of the plurality of groups to different nodes in a tree structure; assigning a label to each branch in the tree structure; and using the tree structure to control an interactive user chat.

In Example 2, the subject matter of Example 1, wherein the operations further comprise: generating a term-frequency matrix comprising a plurality of cells, each cell of the plurality of cells representing a frequency in the plurality of entries of an n-gram of one or more words; and filtering, from the term-frequency matrix, n-grams that have a frequency outside of a predetermined frequency range; wherein the converting of the at least a portion of the text for each entry to a vector representation comprises ignoring the filtered n-grams.

In Example 3, the subject matter of Examples 1-2, wherein the assigning of each group of the plurality of groups to different nodes in a tree structure comprises: assigning each group of the plurality of groups to different nodes in a binary tree structure; and converting the binary tree structure to the tree structure based on a branching factor constraint.

In Example 4, the subject matter of Examples 1-3, wherein the assigning of the plurality of entries to the plurality of groups comprises: performing hierarchical agglomerative clustering based on the vector representations.

In Example 5, the subject matter of Example 4, wherein the performing of the hierarchical agglomerative clustering comprises determining distances between clusters using Ward's distance.

In Example 6, the subject matter of Examples 1-5, wherein the database comprises entries for a plurality of product functions and the accessing of the plurality of entries from the database comprises selecting entries for a single product function.

In Example 7, the subject matter of Examples 1-6, wherein: the tree structure comprises nodes corresponding to components; the plurality of groups correspond to the components; and the assigning of each group of the plurality of groups to the different nodes in the tree structure is based on the components.

Example 8 is a non-transitory computer-readable medium that stores instructions that, when executed by one or more processors, cause the one or more processors to perform operations comprising: accessing, from a database, a plurality of entries, each entry comprising text; converting at least a portion of the text for each entry to a vector representation; based on the vector representations, assigning the plurality of entries to a plurality of groups; assigning each group of the plurality of groups to different nodes in a tree structure; assigning a label to each branch in the tree structure; and using the tree structure to control an interactive user chat.

In Example 9, the subject matter of Example 8, wherein the operations further comprise: generating a term-frequency matrix comprising a plurality of cells, each cell of the plurality of cells representing a frequency in the plurality of entries of an n-gram of one or more words; and filtering, from the term-frequency matrix, n-grams that have a frequency outside of a predetermined frequency range; wherein the converting of the at least a portion of the text for each entry to a vector representation comprises ignoring the filtered n-grams.

In Example 10, the subject matter of Examples 8-9, wherein the assigning of each group of the plurality of groups to different nodes in a tree structure comprises: assigning each group of the plurality of groups to different nodes in a binary tree structure; and converting the binary tree structure to the tree structure based on a branching factor constraint.

In Example 11, the subject matter of Examples 8-10, wherein the assigning of the plurality of entries to the plurality of groups comprises: performing hierarchical agglomerative clustering based on the vector representations.

In Example 12, the subject matter of Example 11, wherein the performing of the hierarchical agglomerative clustering comprises determining distances between clusters using Ward's distance.

In Example 13, the subject matter of Examples 8-12, wherein the database comprises entries for a plurality of product functions and the accessing of the plurality of entries from the database comprises selecting entries for a single product function.

In Example 14, the subject matter of Examples 8-13, wherein: the tree structure comprises nodes corresponding to components; the plurality of groups correspond to the components; and the assigning of each group of the plurality of groups to the different nodes in the tree structure is based on the components.

Example 15 is a method comprising: accessing, by one or more processors and from a database, a plurality of entries, each entry comprising text; converting at least a portion of the text for each entry to a vector representation; based on the vector representations, assigning the plurality of entries to a plurality of groups; assigning each group of the plurality of groups to different nodes in a tree structure; assigning a label to each branch in the tree structure; and using the tree structure to control an interactive user chat.

In Example 16, the subject matter of Example 15 includes generating a term-frequency matrix comprising a plurality of cells, each cell of the plurality of cells representing a frequency in the plurality of entries of an n-gram of one or more words; and filtering, from the term-frequency matrix, n-grams that have a frequency outside of a predetermined frequency range; wherein the converting of the at least a portion of the text for each entry to a vector representation comprises ignoring the filtered n-grams.

In Example 17, the subject matter of Examples 15-16, wherein the assigning of each group of the plurality of groups to different nodes in a tree structure comprises: assigning each group of the plurality of groups to different nodes in a binary tree structure; and converting the binary tree structure to the tree structure based on a branching factor constraint.

In Example 18, the subject matter of Example 17, wherein the assigning of the plurality of entries to the plurality of groups comprises: performing hierarchical agglomerative clustering based on the vector representations.

In Example 19, the subject matter of Example 18, wherein the performing of the hierarchical agglomerative clustering comprises determining distances between clusters using Ward's distance.

In Example 20, the subject matter of Examples 15-19, wherein the database comprises entries for a plurality of product functions and the accessing of the plurality of entries from the database comprises selecting entries for a single product function.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

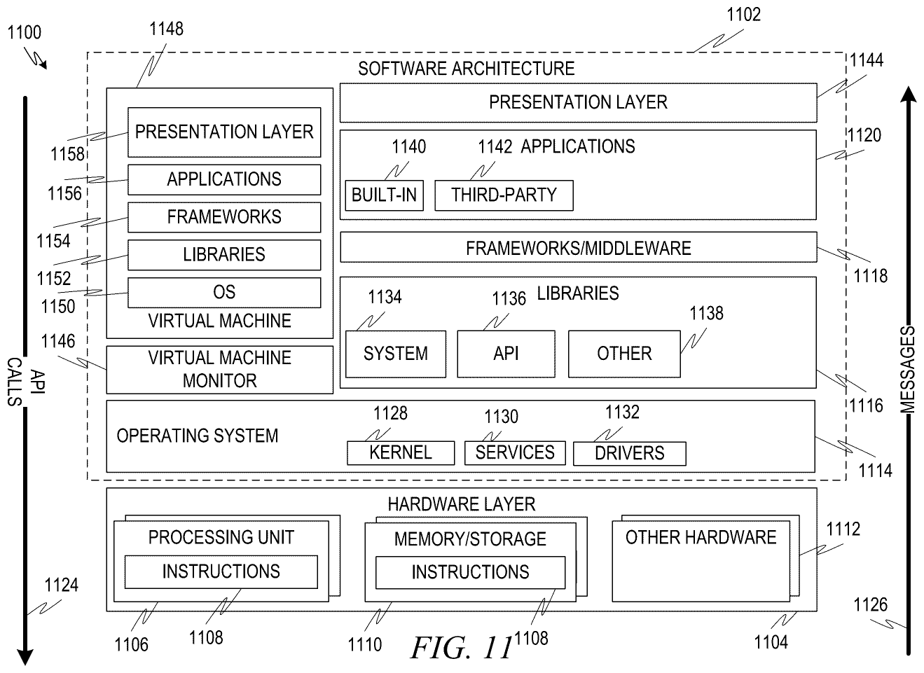

FIG. 11 is a block diagram 1100 showing one example of a software architecture 1102 for a computing device. The architecture 1102 may be used in conjunction with various hardware architectures, for example, as described herein. FIG. 11 is merely a non-limiting example of a software architecture and many other architectures may be implemented to facilitate the functionality described herein. A representative hardware layer 1104 is illustrated and can represent, for example, any of the above referenced computing devices. In some examples, the hardware layer 1104 may be implemented according to the architecture of the computer system of FIG. 11.

The representative hardware layer 1104 comprises one or more processing units 1106 having associated executable instructions 1108. Executable instructions 1108 represent the executable instructions of the software architecture 1102, including implementation of the methods, modules, subsystems, and components, and so forth described herein and may also include memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of the software architecture 1102.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and presentation layer 1144. Operationally, the applications 1120 and/or other components within the layers may invoke application programming interface (API) calls 1124 through the software stack and access a response, returned values, and so forth illustrated as messages 1126 in response to the API calls 1124. The layers illustrated are representative in nature and not all software architectures have all layers. For example, some mobile or special purpose operating systems may not provide a frameworks/middleware 1118 layer, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of an interrupt and, in response, cause the architecture 1102 to pause its current processing and execute an interrupt service routine (ISR) when an interrupt is accessed.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 may provide a higher-level common infrastructure that may be utilized by the applications 1120 and/or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. Third-party applications 1142 may include any of the built-in applications as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1142 may invoke the API calls 1124 provided by the mobile operating system such as operating system 1114 to facilitate functionality described herein.

The applications 1120 may utilize built-in operating system functions (e.g., kernel 1128, services 1130 and/or drivers 1132), libraries (e.g., system libraries 1134, API libraries 1136, and other libraries 1138), frameworks/middleware 1118 to create user interfaces to interact with users of the system. Alternatively, or additionally, in some systems, interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine 1148 as well as the interface with the host operating system (i.e., operating system 1114). A software architecture executes within the virtual machine 1148 such as an operating system 1150, libraries 1152, frameworks/middleware 1154, applications 1156 and/or presentation layer 1158. These layers of software architecture executing within the virtual machine 1148 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 12 is a block diagram of a machine in the example form of a computer system 1200 within which instructions 1224 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation (or cursor control) device 1214 (e.g., a mouse), a storage unit 1216, a signal generation device 1218 (e.g., a speaker), and a network interface device 1220.

### Machine-Readable Medium

The storage unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media 1222.

While the machine-readable medium 1222 is shown in FIG. 12 to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding, or carrying instructions 1224 for execution by the machine and that cause the machine to perform any one or more of the methodologies of the present disclosure, or that is capable of storing, encoding, or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

1. A system comprising:
a memory that stores instructions; and
one or more processors configured by the instructions to perform operations comprising:
accessing, from a database, a plurality of entries, each entry comprising text;
generating a term-frequency matrix comprising a plurality of rows and a plurality of columns, each row of the plurality of rows corresponding to a different entry. each column of the plurality of columns corresponding to a different n-gram of one or more rows, each cell of the term-frequency matrix located at an intersection of a row and a column representing a frequency in the entry of the row of the n-gram of the column;
filtering, from the term-frequency matrix, n-grams that have a frequency outside of a predetermined frequency range;
converting at least a portion of the text for each entry to a vector representation, ignoring the filtered n-grams;
based on the vector representations, assigning the plurality of entries to a plurality of groups;
assigning each group of the plurality of groups to different nodes in a tree structure;
assigning a label to each branch in the tree structure; and
using the tree structure to control an interactive user chat.

2. (canceled)

3. The system of claim 1, wherein the assigning of each group of the plurality of groups to different nodes in a tree structure comprises:
assigning each group of the plurality of groups to different nodes in a binary tree structure; and
converting the binary tree structure to the tree structure based on a branching factor constraint.

4. The system of claim 1, wherein the assigning of the plurality of entries to the plurality of groups comprises:
performing hierarchical agglomerative clustering based on the vector representations.

5. The system of claim 4, wherein the performing of the hierarchical agglomerative clustering comprises determining distances between clusters using Ward's distance.

6. The system of claim 1, wherein the database comprises entries for a plurality of product functions and the accessing of the plurality of entries from the database comprises selecting entries for a single product function.

7. The system of claim 1, wherein:
the tree structure comprises nodes corresponding to components;
the plurality of groups correspond to the components; and
the assigning of each group of the plurality of groups to the different nodes in the tree structure is based on the components.

8. A non-transitory computer-readable medium that stores instructions that, when executed by one or more processors, cause the one or more processors to perform operations comprising:
accessing, from a database, a plurality of entries, each entry comprising text;
generating a term-frequency matrix comprising a plurality of rows and a plurality of columns, each row of the plurality of rows corresponding to a different entry, each column of the plurality of columns corresponding to a different n-gram of one or more rows, each cell of the term-frequency matrix located at an intersection of a row and a column representing a frequency in the entry of the row of the n-gram of the column;
filtering, from the term-frequency matrix, n-grams that have a frequency outside of a predetermined frequency range;
converting at least a portion of the text for each entry to a vector representation, ignoring the filtered n-grams;
based on the vector representations, assigning the plurality of entries to a plurality of groups;
assigning each group of the plurality of groups to different nodes in a tree structure;
assigning a label to each branch in the tree structure; and
using the tree structure to control an interactive user chat.

9. (canceled)

10. The non-transitory computer-readable medium of claim 8, wherein the assigning of each group of the plurality of groups to different nodes in a tree structure comprises:
assigning each group of the plurality of groups to different nodes in a binary tree structure; and
converting the binary tree structure to the tree structure based on a branching factor constraint.

11. The non-transitory computer-readable medium of claim 8, wherein the assigning of the plurality of entries to the plurality of groups comprises:
performing hierarchical agglomerative clustering based on the vector representations.

12. The non-transitory computer-readable medium of claim 11, wherein the performing of the hierarchical agglomerative clustering comprises determining distances between clusters using Ward's distance.

13. The non-transitory computer-readable medium of claim 8, wherein the database comprises entries for a plurality of product functions and the accessing of the plurality of entries from the database comprises selecting entries for a single product function.

14. The non-transitory computer-readable medium of claim 8, wherein:
the tree structure comprises nodes corresponding to components;
the plurality of groups correspond to the components; and
the assigning of each group of the plurality of groups to the different nodes in the tree structure is based on the components.

15. A method comprising:
accessing, by one or more processors and from a database, a plurality of entries, each entry comprising text;
generating a term-frequency matrix comprising a plurality of rows and a plurality of columns, each row of the plurality of rows corresponding to a different entry, each column of the plurality of columns corresponding to a different n-gram of one or more rows, each cell of the term-frequency matrix located at an intersection of a row and a column representing a frequency in the entry of the row of the n-gram of the column;
filtering, from the term-frequency matrix, n-grams that have a frequency outside of a predetermined frequency range;
converting at least a portion of the text for each entry to a vector representation, ignoring the filtered n-grams;
based on the vector representations, assigning the plurality of entries to a plurality of groups;
assigning each group of the plurality of groups to different nodes in a tree structure;
assigning a label to each branch in the tree structure; and
using the tree structure to control an interactive user chat.

16. (canceled)

17. The method of claim 15, wherein the assigning of each group of the plurality of groups to different nodes in a tree structure comprises:
assigning each group of the plurality of groups to different nodes in a binary tree structure; and
converting the binary tree structure to the tree structure based on a branching factor constraint.

18. The method of claim 17, wherein the assigning of the plurality of entries to the plurality of groups comprises:
performing hierarchical agglomerative clustering based on the vector representations.

19. The method of claim 18, wherein the performing of the hierarchical agglomerative clustering comprises determining distances between clusters using Ward's distance.

20. The method of claim 15, wherein the database comprises entries for a plurality of product functions and the accessing of the plurality of entries from the database comprises selecting entries for a single product function.

21. The method of claim 15, wherein:
the tree structure comprises nodes corresponding to components;
the plurality of groups correspond to the components; and
the assigning of each group of the plurality of groups to the different nodes in the tree structure is based on the components.
